(19) United States
(12) Patent Application Publication
(10) Pub. No.: US 2008/0233394 A1
(43) Pub. Date: Sep. 25, 2008

(54) Adhesive Tape Comprising a Polyacrylate Foam Support

(75) Inventors: Reinhold Domanski, Neuwied (DE); Anke Lewin, Dusseldorf (DE); Wolfgang Klauck, Meerbusch (DE)

Correspondence Address: SCHWEGMAN, LUNDBERG & WOESSNER, P.A., P.O. BOX 2938, MINNEAPOLIS, MN, 55402, US

(73) Assignee: LOHMANN GMBH & CO.KG, Neuwied (DE)

(21) Appl. No.: 11/630,821

(22) PCT Filed: Jun. 22, 2005
(86) PCT No.: PCT/EP05/06731

§ 371 Date: Nov. 8, 2007

(30) Foreign Application Priority Data
Jun. 25, 2004 (DE) 20 2004 009 994.2

(51) Int. Cl. C09J 7/02

(52) U.S. Cl. 428/352; 428/343; 428/355 AC

(57) ABSTRACT

The invention relates to an adhesive tape comprising a support that is provided with a first and a second face. Said support is embodied as an acrylate foam tape while the first face and the second face are provided with at least two respective segments which are coated with different adhesives. At least one first adhesive is provided with great initial tack while at least one second adhesive is provided with great final tack.

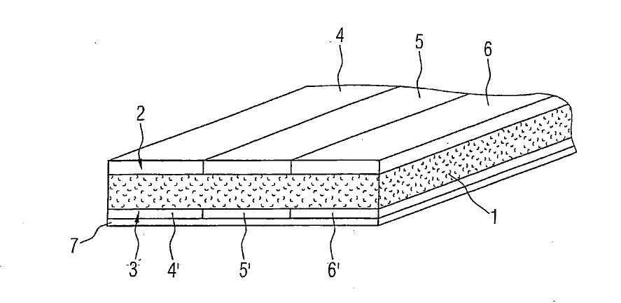

The invention relates to an adhesive tape which comprises a carrier having a first side and a second side.

Adhesive tapes are known, and available on the market, in a great multiplicity of forms. They are generally composed of a carrier which comprises a relatively thin flexible polymeric film coated with an adhesive. Typically carrier materials are polypropylene, polyethylene, polyethylene terephthalate, polyvinyl chloride and acetate film, and also fabric carriers and foam carrier materials. Adhesive tapes are used for joining or bundling articles, for sealing or, for example, in the context of painting operations, for masking, i.e., for hiding areas which are not to be covered with paint.

The carrier of adhesive tapes may be coated on one or both sides with adhesive. Adhesive tapes coated with adhesive on both sides are also referred to as assembly tapes and are used for the purpose of fastening articles having at least one planar side to a planar substrate. They can be used, for example, to fasten pictures, mirrors or signs to a wall.

The adhesives for producing adhesive tapes may be selected from a great multiplicity of customary materials. The materials in question may, for example, be SIS rubbers, SBS rubber, polyisobutylenes, polyisoprenes, polyacrylates and natural rubbers, with or without the addition of tackifying natural and/or synthetic resins. On the basis of their different chemical compositions, the different adhesives of course have different properties. Important quality features of an adhesive assembly tape are initial adhesion, bond strength to the substrate, cohesion of the adhesive, thermal stability, and ultimate strength. In the context of adhesive tape application it is important to press the assembly tape onto the particular substrate effectively, in order to ensure effective wetting of the tape to the substrate. The tape achieves its ultimate strength when the maximum possible wetting of the adhesive to the substrate has been achieved. In order to flow into the microscopic surface unevennesses, the pressure-sensitive adhesive generally requires a certain time. The process is favored by relatively high temperatures and a strong pressing force. Adhesives which attain a high ultimate strength and a high thermal stability generally require a relatively long time in order to perform this wetting operation. On the other hand, there are adhesives which exhibit a high tack and are relatively fluid; these adhesives wet the bond substrate much more quickly and therefore also adhere much more quickly to the substrate in question. These adhesives, however, generally do not attain high ultimate strengths and thermal stabilities.

It is an object of the present invention to specify an adhesive tape which on the one hand, immediately following its application, leads to a bond with a relatively high load-bearing capacity and after a certain time leads to a bond having a very high load-bearing capacity, and on the other hand is suitable for joining articles which exhibit minimal surface unevennesses.

This object is achieved in the case of an adhesive tape of the type specified at the outset by virtue of the fact that the carrier is a polyacrylate foam tape and that the first and second sides each have at least two segments coated with different adhesives of which at least one first adhesive has a high initial bond strength and at least one second adhesive has a high ultimate bond strength.

An adhesive tape with which on one side different adhesives cover segments of the carrier that border one another is known in principle from patent application US 2002/0108564 A1. The inventively essential combination with a polyacrylate foam tape, leading to particularly high-performance assembly tapes, is not specified in said patent application, however.

The segments which carry the different adhesives are advantageously in the form of adjacent strips which run in the longitudinal direction of the adhesive tape. A tape of this kind can be easily produced by applying the adhesives in strip form to the carrier, and also affords considerable advantages in its application.

On each side of the adhesive tape it is possible to combine two or more adhesives with one another, disposed adjacently in strip form, there being no limit on the number of strip-form segments. In the case of the adhesive tape of the invention it is particularly advantageous, however, if on each side of the carrier a first strip-shaped segment is coated with an adhesive having high initial bond strength and two further strip-shaped segments, which border on the longitudinal sides of the first strip-shaped segment, are coated with an adhesive having high ultimate bond strength. The adhesive strip with high initial bond strength thus extends in the middle of the tape, while the adhesive strips with high ultimate bond strength extend at the edges. The three strips may each occupy one third of the width of the adhesive tape, but it is also possible to vary the strip width accordingly in favor of a high initial bond strength or in favor of a high ultimate bond strength.

The adhesive tape advantageously has on stainless steel after one minute a bond strength of >12 N/25 mm and after 24 hours a bond strength of >30 N/25 mm, the bond strength corresponding to the peel strength measured in accordance with the PSTC-1 test method. The test method was developed by the Pressure Sensitive Tape Council, a federation of American adhesive tape manufacturers. According to the test conditions the bond strength is the force required to remove an adhesive strip in a defined width under defined conditions (peel angle, applied pressure, speed) from a standard test plate. For testing, a section of adhesive tape with a length of about 400 mm and a sample width of 25 mm is applied to a stainless steel plate 200 mm long, 50 mm wide and approximately 2 mm thick and is pressed on uniformly using a rubber-coated metal roller weighing 2 kg. About 25 mm of adhesive tape are peeled from the steel plate prepared in this way. The steel plate is fixed in the testing instrument using a carrier clamp, and the free end of the tape is fastened with another clamp. At a defined speed of 300+/−30 mm per minute, the adhesive tape is peeled at an angle of 180° from the steel plate, the testing instrument displaying the bond strength values. After the end of the test a mean value is calculated which represents the bond strength value on steel. This value is expressed with the force (N) required to peel the adhesive tape from the steel surface, for a sample width of 25 mm.

Of particular preference the adhesives and the adhesive tape overall have the following properties:

Adhesive having high initial bond strength:
Peel strength on steel after 1 minute: >40 N/25 mm
Peel strength on steel after 24 hours: >50 N/25 mm
Temperature stability ≧50° C.
Adhesive having high ultimate bond strength:
Peel strength on steel after 1 minute: >15 N/25 mm
Peel strength on steel after 24 hours: >30 N/25 mm
Temperature stability ≧100° C.
Adhesive tape overall:
Peel strength on steel after 1 minute: >12 N/25 mm
Peel strength on steel after 24 hours: >30 N/25 mm
Temperature stability ≧95° C.

Besides the bond strength, the temperature stability is a further quality feature of an adhesive tape. With advantage, the adhesive having high initial bond strength has a temperature stability of ≧70° C. and the adhesive having high ultimate bond strength has a temperature stability of ≧100° C. The adhesive having high initial bond strength is advantageously a synthetic rubber adhesive, preferably a styrene-isoprene-styrene rubber, and the adhesive having high ultimate bond strength is advantageously an acrylate adhesive, preferably an acrylate adhesive based on 2-ethyl acrylate.

Advantageously the adhesive tape has a release film, at least on one of the adhesive-coated sides of the carrier. A release film of this kind is also referred to as a release liner. It facilitates the handling of the adhesive tape prior to its use, and in particular makes it possible for the tape to be wound up and also unwound easily for the use of the adhesive tape.

The adhesive tape of the invention can be produced by methods which are well known in the art, by coating the foam carrier with the different adhesives in strip form using known coating machines.

A working example of the invention is illustrated below with reference to the drawing.

The FIGURE shows, in perspective view, an adhesive tape according to the invention. This tape is composed of a polyacrylate form carrier 1. Disposed on the first side 2 and on the second side 3 of the carrier are adhesive-coated segments 4, 5 and 6 and 4′, 5′ and 6′, respectively. In this case the segments 5 and 5′ are coated with an adhesive having high initial bond strength and the segments 4, 4′, 6 and 6′ are coated with an adhesive having high ultimate bond strength. A release film 7 is disposed on one side of the adhesive tape.

1. An adhesive tape comprising a carrier (1) having a first side (2) and second side (3), characterized in that the carrier is an acrylate foam tape and in that the first and the second sides each have at least two segments (4, 5, 6, 4′, 5′, 6′) coated with different adhesives of which at least one first adhesive has a high initial bond strength and at least one second adhesive has a high ultimate bond strength.

2. The adhesive tape of claim 1, wherein the segments are in the form of adjacent strips which run in the longitudinal direction of the adhesive tape.

3. The adhesive tape of claim 2, wherein on each side of the carrier (1) a first strip-shaped segment (5, 5′) is coated with an adhesive having high initial bond strength and two further strip-shaped segments (4, 4′, 6, 6′), which border on the longitudinal sides of the first strip-shaped segment, are coated with an adhesive having a high ultimate bond strength.

4. The adhesive tape of claim 1, wherein upon application to stainless steel, the adhesive tape has after one minute a bond strength of >12 N/25 mm and after 24 hours a bond strength of >30 N/25 mm, the bond strength corresponding to the peel strength measured in accordance with the PSTC-1 test method.

5. The adhesive tape of claim 1, wherein the adhesive having high initial bond strength has a temperature stability of ≧70° C. and the adhesive having high ultimate bond strength has a temperature stability of ≧100° C.

6. The adhesive tape of claim 1, wherein the adhesive having high initial bond strength is a synthetic rubber adhesive and the adhesive having high ultimate bond strength is an acrylate adhesive.

7. The adhesive tape of claim 1, wherein the carrier is composed of a closed-cell acrylate foam.

8. The adhesive tape of claim 1, further comprising a release film (7) on at least one of the adhesive-coated sides of the carrier (1).
